(19) United States
(12) Patent Application Publication
(10) Pub. No.: US 2006/0291130 A1
(43) Pub. Date: Dec. 28, 2006

(54) Spraying device

(76) Inventors: John Farrell Hughes, Southampton (GB); Lindsey Faye Gaunt, Southampton (GB)

Correspondence Address: NORRIS, MCLAUGHLIN & MARCUS, 875 THIRD AVE, 18TH FLOOR, NEW YORK, NY, 10022, US

(21) Appl. No.: 10/482,193

(22) PCT Filed: Jul. 5, 2002
(86) PCT No.: PCT/GB02/03100

§ 371 Date: Dec. 23, 2003

(30) Foreign Application Priority Data
Jul. 6, 2001 (GB) 0116543.0

(51) Int. Cl. H05F 3/00

(52) U.S. Cl. 361/220

(57) ABSTRACT

A method of imparting a charge to droplets of a liquid which is dispensed from a trigger actuated spray device in which charge is generated by the triboelectric rubbing together of two materials and one polarity of charge is transferred to the liquid at the point of atomisation. Apparatus for imparting a charge to droplets of a liquid which is dispensed from a trigger actuated spray device includes means for generating triboelectric charge by actuation of the trigger.

The present invention relates to a method and associated apparatus for spraying, and in particular to an improvement in the distribution of atomised liquid droplets from a trigger actuated spray device.

Dispensing liquids in aerosol form is now widely used for ease and optimising the delivery and function of domestic care products. Pressure-packed, or aerosol containers are now almost universally adopted for the application of products such as polishes, body and hair care spray, insecticides and fabric care sprays and the like. Generally, the enhanced performance and public acceptance of such spray products lies on the extremely good atomising characteristics associated with the pressure-packed aerosol containers. Dispensing the product is effortless, and atomisation and delivery is good. With recent developments this performance has been further enhanced following the incorporation of electrostatic technology into standard aerosol cans.

In addition to pressurised aerosol containers, many domestic and personal care products are also dispensed through manually operated trigger packs. These products are packed at atmospheric pressure, and contain no gassing agents. This in turn leads to very different atomising characteristics, when compared to aerosol dispensers.

WO-A-99/01227 describes how natural charge exchange phenomena have been harnessed and incorporated into a standard aerosol can. This is achieved without the need for any active electrical circuitry.

Due to numerous different parameters however, such as pressure, velocity, energy-input etc, the electrostatic mechanism developed by the aerosol in the above-mentioned document is not easily transferable to trigger actuated spray devices. This is because the mechanism for atomising liquids from trigger actuated dispensers relies solely on the energy associated with squeezing the trigger, rather than using a gas under pressure. A different charge generation and separation technique therefore must be adopted. As in aerosol dispensers, it is necessary that this is achieved without the use of an active electrically powered circuit.

We have now developed a method whereby an additional charge may be imparted to droplets of a liquid which is dispensed from a trigger actuated spray device. Charge is generated by the triboelectric rubbing together of two materials and one polarity of charge is transferred to the liquid at the point of atomisation.

Accordingly, the present invention provides a method of dispensing charged liquid droplets from a trigger actuated spray device comprising the steps of:

coupling a trigger to a means for dispensing a predetermined volume of a liquid from a reservoir of the liquid and to a first charge means;

dispensing the predetermined volume of liquid by the actuation of said trigger;

connecting an outlet means to the means for dispensing the predetermined volume of the liquid;

intimately coupling the first charge means to a second charge means, the first charge means and the second charge means comprising different tribocharging materials and moving relative to each other upon actuation of the trigger;

imparting a first charge on the first charge means and a second charge on the second charge means by actuation of the trigger; and

arranging for charge separation to occur and transferring one polarity of the separated charge to the liquid being dispensed.

It is well known that when two different materials are in frictional contact with each other, a re-organisation of charge occurs at the point of contact. This phenomenon is well documented, and is known as “Tribo Charging” (Taylor and Secker. 1994). By appropriate choice of material, it is possible to arrange for charge separation to occur between various components of the trigger unit. If one polarity of the separated charge is transferred to the atomised liquid, it naturally follows that the net charge conveyed by the atomised liquid will be enhanced.

This mechanism is seen as a two-stage process. First, the charge must be separated, and secondly one polarity of the separated charge must be transferred to the liquid. As described in WO-A-99/01277, in order that the benefits of electrostatic spraying are obtained, then the ratio of the charge to the mass of liquid being dispensed must be at least 1×10⁻⁴ C/kg.

Charge may be transferred to the liquid by two mechanisms. Charge can be transferred by contact with an electrode, removing static charge from a charge storage area. This is the contact method. Alternatively, the liquid can be charged by induction, whereby the static charge is located around the point of liquid atomisation, creating an electric field. When the liquid is atomised in the high electric field area, charge is then induced in the droplets as they form.

In the contact method of charging the charge is transferred to the liquid from the charge storage area, by contact of the liquid with this area so sufficient charge must reside in this area for the atomised liquid to acquire a minimum charge-to-mass ratio of 1×10⁻⁴ C/kg. If the mass of product delivered is, typically, about 0.5 g per squeeze of the trigger, then it is clear that the total charge to be transferred to the spray must be approximately 0.5×10⁻⁷ C. Normally actuated trigger packs will donate a certain level of charge. Depending on the type of trigger unit, and product being dispensed, the charge-to-mass ratio will vary typically between 1×10⁻⁸ C/kg and 1×10⁻⁵ C/kg. For the higher charging variants, it is clear that the addition of approximately 0.5×10⁻⁷ C will be sufficient to enhance the overall charging level to a value of charge-to-mass ratio approximately to the required level of 1.0×10⁻⁴ C/kg.

In the induction method, the charge is not directly transferred to the liquid, but remains in the charge storage area. Equal and opposite charge is induced on the liquid by induction. Therefore, the magnitude of the electric field is important in determining the charge-to-mass ratio of the sprayed liquid. The liquid reservoir is preferably grounded for optimum performance.

For both mechanisms of imparting charge to a liquid during atomisation from a trigger actuated spray device, the higher the charge developed during the triboelectric charge separation, the higher the charge-to-mass ratio of the generated sprayed droplets of liquid.

The present invention also includes within its scope apparatus for carrying out the method of the present invention.

Accordingly, in a further aspect of the present invention there is provided a spray device for dispensing charged liquid droplets comprising;
a trigger coupled to a means for dispensing a predetermined volume of a liquid and to a first charge means;
said means for dispensing the liquid being arranged to dispense the predetermined volume of liquid by actuation of the trigger;
outlet means coupled to the means for dispensing the predetermined volume of liquid;
the first charge means being intimately coupled to a second charge means, whereby actuation of the trigger permits movement of the first charge means relative to the second charge means, and thereby imparts a first charge on the first charge means and a second charge on the second charge means;
the first charge means being further arranged to be within close proximity of the outlet means; and
the first and second charge means comprising different tribocharging materials.

The spray device of the present invention allows a charge to be imparted to a liquid dispensed from a trigger actuated spray device. This imparted charge enable the spray to more easily contact a surface and thus the dispensed liquid is more efficiently used.

In a first embodiment of the apparatus of the present invention, the spray device may further comprise charge conducting means connectively coupled to the first charge means. This allows the charge generated by the relative movement of the first and second charging means to be conducted to other locations within the spray device. Preferably the conducting means will be coupled to an electrode arranged such that a substantial proportion of liquid droplets are in forcible collision with the electrode means after atomisation. This contact arrangement allows the charge collected on the electrode to be transferred to the liquid droplets as they are dispensed from the device.

The electrode may, for example, comprise a disc of conducting material coupled to a nozzle means for dispensing the liquid.

Alternatively, the electrode may comprise a point electrode isolated from a nozzle means for dispensing the liquid.

Alternatively, the electrode may comprise a toroid positioned in front of a nozzle means for dispensing the liquid.

In a second embodiment of the present invention, the spray device may further comprise a charge storage means arranged so that an electric field created by the charge present on the charge storage means is exerted, in use, on a substantial portion of the liquid during atomisation. This inductive transfer arrangement allows the charge to be imparted to the liquid at the point of atomisation. In this arrangement the conducting means may not be required as the charge may be generated in situ and so therefore may not need to be transferred within the spraying device. This inductive transfer arrangement allows the charge to be imparted to the liquid at the point of atomisation.

In use the first and second embodiments will also comprise a liquid reservoir connectively coupled to pump means. The said liquid reservoir is arranged to store the liquid which is to be dispensed.

The first charge means will preferably consist of a conducting material for example aluminium, celluloid or a conducting or static dissipative polymer which may partially be filled with carbon black or metallic elements.

The said second charge means may consist of a polyfluorinated hydrocarbon polymer, such as Teflon® or polyethylene.

The present invention will now be described by way of example only and with reference to the accompanying drawings in which:

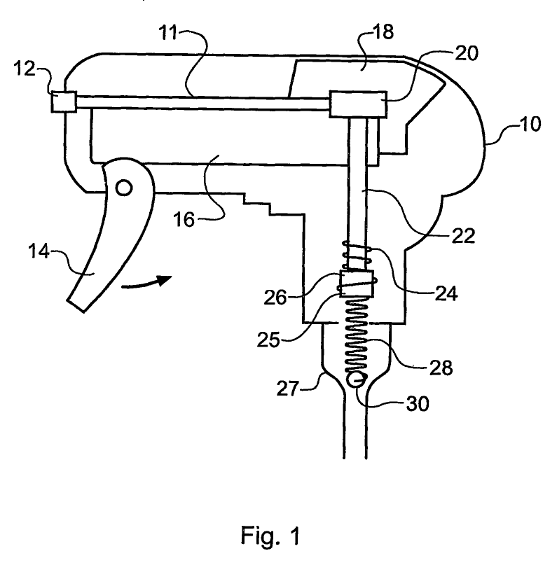

FIG. 1 illustrates a side view of a known spraying device;

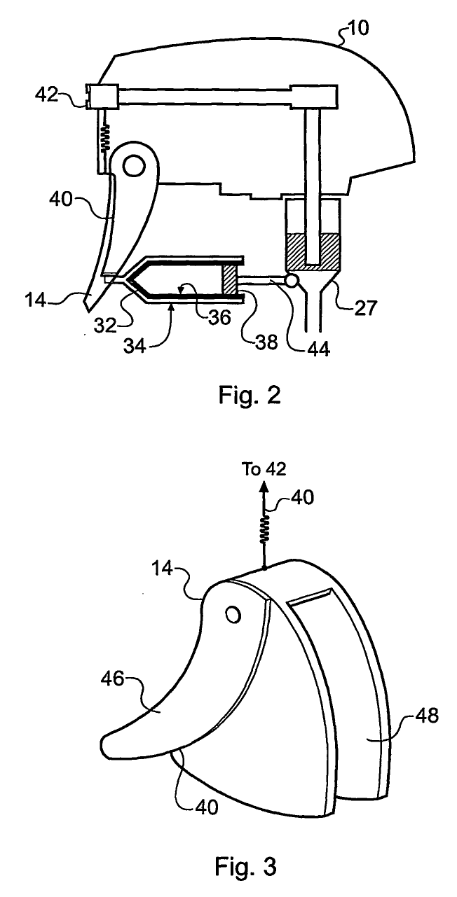

FIG. 2 illustrates a side view of spraying device in accordance with one embodiment of the present invention;

FIG. 3 illustrates a perspective view of a trigger in accordance with one embodiment of the present invention;

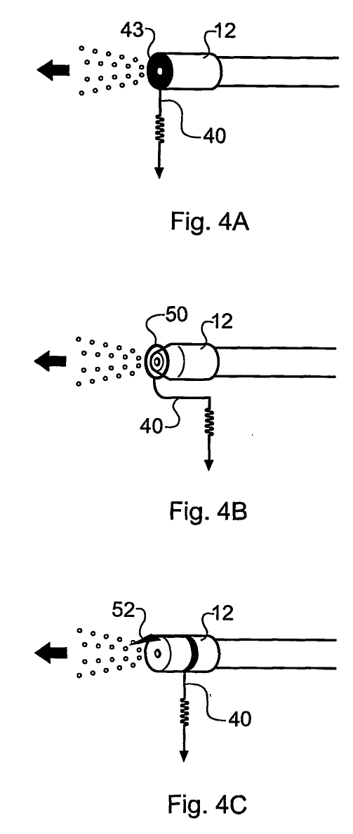

FIG. 4a illustrates a nozzle arrangement in accordance with one embodiment of the present invention;

FIG. 4b shows an alternative nozzle arrangement in accordance with a further embodiment of the present invention;

FIG. 4c shows yet another alternative nozzle arrangement in accordance with a still further embodiment of the present invention;

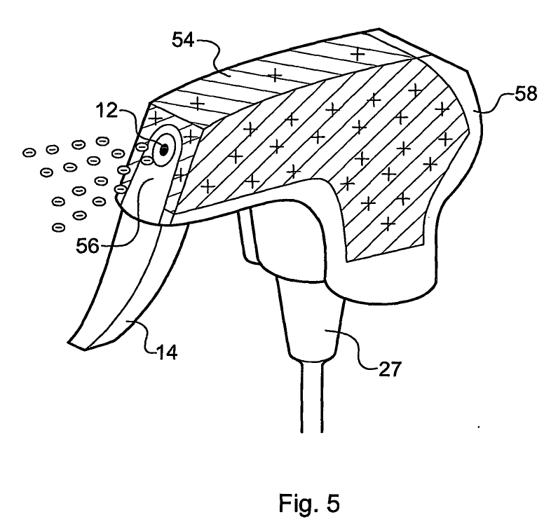

FIG. 5 shows a perspective drawing of an inductive transfer arrangement in accordance with the present invention;

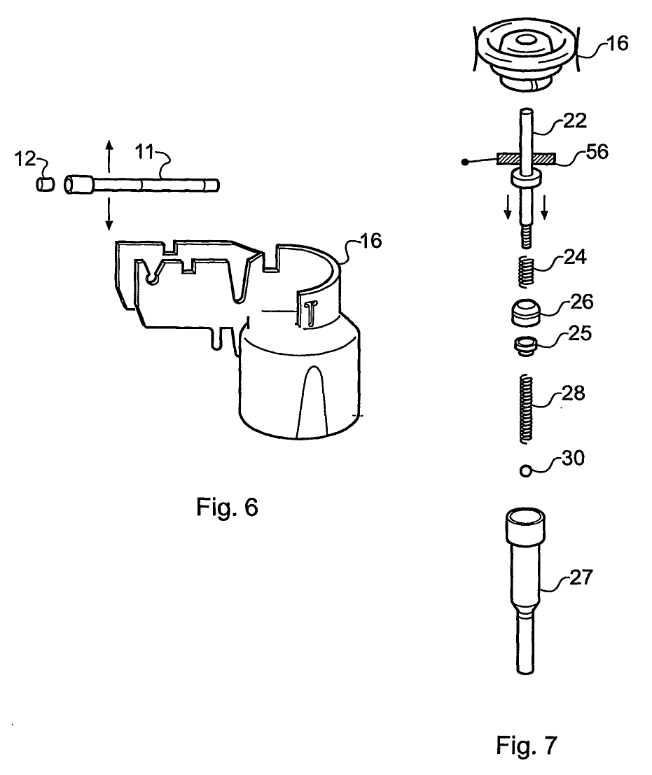

FIG. 6 shows a perspective view of a part of a spraying device in accordance with the present invention;

FIG. 7 shows a perspective drawing of another part of a spraying device in accordance with the present invention; and

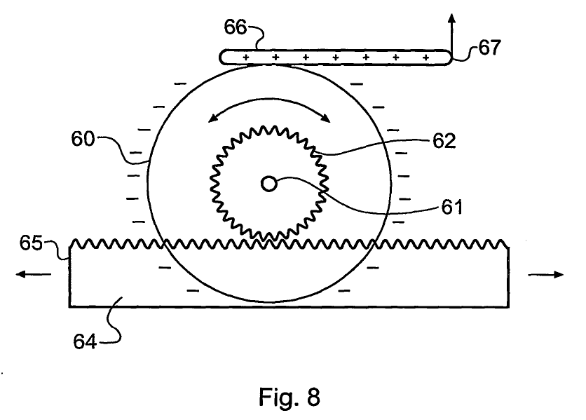

FIG. 8 shows a perspective drawing of a charge transfer arrangement in accordance with a further embodiment of the invention.

Referring to FIG. 1, a known spraying device 10 for atomising and dispensing a predetermined volume of liquid that is stored at atmospheric pressure is shown.

The spraying device 10 includes a trigger 14, formed in a conventional manner for example from a plastics material, allowing the user to dispense liquid from the spraying device. The device 10 also includes a nozzle 12 for atomising the liquid as it is passed therethrough. The nozzle 12 is usually formed from a plastics material and may be adjusted to alter the formation characteristics of the spray, for example the nozzle 12 may be adjusted to allow the spray to be expelled as a jet of liquid or as a fine mist.

The spraying device 10 also includes an actuator 20, an actuator extension 11 and a stem 22. The actuator extension 11 connects the actuator 20 to the nozzle 12. The stem 22 is also connected to the actuator 20, in this case, substantially perpendicularly to the actuator extension 11. One purpose of the actuator 20, the actuator extension 11 and the stem 22 is to allow the movement of the liquid from a reservoir (not shown) where it is stored to the nozzle 12 when actuation of the trigger 14 occurs. This will be explained hereinafter.

The actuator 20, actuator extension 11 and stem 22 are typically manufactured from a plastics material as is known in the art.

A chassis 16 is also provided within the spraying device 10. The chassis 16 connects the trigger 14 to the actuator 20 and the actuator extension 11. To be more specific, typically, the actuator extension 11 is connectively coupled along the length of its underside to the upper side of the chassis 16. The way in which the chassis 16, the actuator extension 11, the actuator 20 and the trigger 14 are coupled is well known and will therefore not be described in any detail here. It should be noted however that upon actuation of said trigger 14, the chassis 16 moves relative to the actuation extension 11.

Further contained within the spraying device 10 is a rocking lever 18. This is connectively coupled to the upperside of the actuator 20, and the chassis 16. The purpose of the rocking lever 18 is, upon actuation of the trigger 14, to apply a downward force to the actuator 20 and therefore the stem 22. This will be explained in more detail hereinafter. As is known, the rocking lever 18 is typically formed from plastics material or the like. The way in which the rocking lever 18 is connectively couple to the actuator 20 and the chassis 16 is well known in the art and will not be described any further herein.

The stem 22 is also connected to a piston 26. The upper side of the piston 26 is connected to the stem 22 at the end thereof opposite the actuator 20. There is also attached between the stem 22 and the piston 26 a precompression spring 24. The purpose of the precompression spring 24 and piston 26 will be described in detail later.

Coupled to the lower side of the piston 26 is the upper side of a poppet valve 25. Connectively coupled to the lower side of the poppet valve 25 is an actuation spring 28. The actuation spring 28 is inserted into a body 27 and applies an upwards substantially vertical force to the poppet valve 25. The body 27 is typically formed of plastics material and is inserted, in use, into a reservoir of liquid (not shown). The body 27 therefore connects the reservoir of liquid to the spray device 10. At the lower end of the actuation spring 28 is a ball 30. The ball 30 can be made of metal or a plastics material or the like. The ball 30 is substantially the same diameter as the actuation spring 28 and the lower end of the body 27.

The purpose of each of the components of FIG. 1 will now be described in relation to the actuation of the trigger 14.

When a user wishes to dispense a predetermined volume of liquid using the known spraying device 10, the trigger 14 is actuated. Typically this is achieved by the user squeezing the trigger 14, although other methods may be employed as will be familiar to a skilled person, such as pushing the trigger 14.

When the trigger 14 is in the resting state, as depicted in FIG. 1, the predetermined volume of liquid is stored in the cavity defined by lower side of the poppet valve 25 and the lower end of the body 27.

The ball 30 isolates the lower end of the body 27 from the reservoir of liquid (not shown) in a liquid tight manner. The ball 30 therefore stops the liquid from entering the reservoir once it has been transferred into the spraying device 10.

When the trigger 14 is in the resting position, the pressure within the spraying device, and more specifically, at the piston 26 and poppet valve 25, is substantially at atmospheric pressure. The poppet valve 25 and the piston 26 are arranged so that at substantially atmospheric pressure, no liquid will flow therethrough. This means that the liquid in the body 27 is isolated from the stem 22.

Once a user wishes to dispense a predetermined volume of liquid, the trigger 14 is actuated in the direction of the arrow. As the tr: applies a downward force onto the stem 22. This downward force is sufficient to overcome the upward force applied to the stem 22 by the precompression spring 24. Under this force, the stem 22 is also displaced vertically. As will be appreciated by one skilled in the art, as the stem 22 and actuator 20 are vertically displaced, there is relative movement between the actuator 20 and stem 22 with respect to the chassis 16.

As the upper surfaces of the piston 26 and poppet valve 25 are intimately coupled to the stem 22, the piston 26 and poppet valve 25 are also displaced vertically. The displacement of the piston 26 and poppet valve 25 is in opposition to the force applied to the poppet valve 25 by the actuation spring 28.

As the actuation spring 28 is compressed due to the force applied to it by the vertical displacement of the poppet valve 25, the space within the body 27 in which the known volume of liquid is located, is reduced. This is because the ball 30 forms a liquid tight seal between the body 27 and the liquid reservoir (not shown) and so prevents the liquid from flowing back into the reservoir. This reduction in space within the body 27 therefore increases the pressure which the liquid applies to the poppet valve 25 and the piston 26.

The piston 26 and the poppet valve 25 are arranged so that as the pressure applied to the piston 26 and the poppet valve 25 increases beyond a threshold, liquid is allowed to pass from the body 27 to the stem 22. This liquid is now under pressure and flows through the stem 22, through the actuator 20, through the actuator extension 11 and to the nozzle 12. The liquid arrives at the nozzle 12 under pressure and is passed therethough.

Once the actuation of the trigger 14 is complete, the trigger 14 returns to the resting position as depicted in FIG. 1. In this state, the rocking lever 18 reduces the downward force applied to the stem 22 so that there is an upward force applied to the stem 22 by the precompression spring 24. This allows the stem 22 to move vertically back to the resting position. Accordingly, the poppet valve 25 and the piston 26 move vertically. This in turn allows the actuation spring 28 to expand to the resting position.

It is important to note that as the poppet valve 25 and the piston 26 move back to the resting position, liquid is drawn up from the reservoir (not shown). This is because the piston 26 and poppet valve 25 form a liquid tight seal between the body 27 and the stem 22, so that as the piston 26 and the poppet valve 25 move vertically, the pressure within the body 27 is reduced. The ball 30 is also displaced from the lower end of the body 27 because of this reduction in pressure and so allows liquid to flow from the reservoir (not shown) into the body 27. Once the spraying device 10 fully returns to the resting position, the ball 30 returns to the lower end of the body 27 as described previously.

It should be noted that this is only a typical example of a known spraying device and its operation is for reference only.

FIG. 2 shows a side view of one embodiment of the present invention. A typical spraying device 10 is shown as previously described. However, in this case, there is additionally provided a first charge means 32. The first charge means 32 comprises a cylinder having an outer layer 34 and an inner layer 36. Movably inserted within the first charge means 32 is a second charge means 38 comprising a piston. The outer edge of the second charge means 38 is in close contact with the inner layer 36 of the first charge means 32. The second charge means 38 is free to slide within the first charge means 32. Attached to a face of the second charge means 38 is a substantially rigid rod connection 44. The rod connection 44 is also attached to the body 27 of the spraying device 10. The rod connection 44 therefore couples the second charge means 38 to the body 27 of the spaying device 10. The rod connection 44 may be made of a plastics material or any other insulating material.

The first charge means 32 is connectively coupled to the trigger 14. This means that, as the trigger 14 is horizontally displaced, the first charge means 34 is also horizontally displaced. As the second charge means 38 is rigidly coupled to the body 27, this results in the first charge means 32 moving horizontally with respect to the second charge means. The second charge means 38 therefore slides within the first charge means 32.

The sliding of the first charge means 32 relative to the second charge means 38 is used to generate a charge on both the inner layer 36 of the first charge means 32 and the outer surface of the second charge means 38. This type of charging is known in the art as “tribocharging”. The principles behind this mechanism are known and need not be discussed any further here. It should be noted, however, that materials that exhibit a tribocharging effect are categorised in the Triboelectric Series.

The materials from which the inner layer 36 of the first charge means 32 and the outer surface of the second charge means 38 are made determine the amount of charge and the polarity of charge generated. The choice of material is determined by the Triboelectric Series. The inner layer 36 of the first charge means 32 may, for example, be made from aluminium and the outer surface of the second charge means 38 may be made from Teflon®. The aluminium retains a positive charge whereas the Teflon® retains a negative charge. This may be predicted from the Triboelectric Series. A further combination is for the inner layer 36 of the first charge means 32 to be made from celluloid and the outer surface of the of the second charge means 38 to be made from polyethylene. Many combinations of materials exist from which the inner layer 36 of the first charge means 32 and the outer surface of the second charge means 38 may be made.

The inner layer 36 of the first charge means 32 may be made of the same material as the outer layer 34 of the first charge means 32 or may be made from a different material. Additionally, the outer surface of the second charge means 38 may be made from the same material as the rest of the second charge means 38, or may be made from a different material. Preferably, the inner layer 36 of the first charge means 32 is made from the same material as the outer layer of the first charge means 32, and the outer surface of the second charge means 38 is made of the same material as the rest of the second charge means 38.

As the two different triboelectric materials move slidably relative to each other, a charge of one polarity is retained on the first charge means 32 and a charge of the opposite polarity is retained on the second charge means 38. It is necessary therefore to separate the charge retained in this case, on the first charge means 32. It is therefore preferable that, in this described case, the first charge means 32 is made from a conducting triboelectric material, for example a conducting or static dissipative polymer, which may also be filled with carbon black or metallic elements to increase the conductivity thereof.

It will be understood that the second charge means 38 may be made of a conducting triboelectric material. Hereinafter therefore, it is understood that as an alternative to the described embodiment, the second charge means 38 may perform the functions of the described first charge means 32 and vice versa.

Referring again to FIG. 2, the trigger 14 of the typical spraying device 10 also contains a conducting element 40 coupled at one end to the first charge means 32 and at the other end to an electrode 42. The purpose of the electrode 42 will be described hereinafter. The conducting element 40 may be made from any conducting material, such as aluminium or copper. The conducting element 40 may also be made of the same material as the first charge means 32. The purpose of the conducting element 40 is to transfer the charge between, in this case, the first charge means 32 and the electrode 42. It is anticipated, therefore, that the conducting element 40 should not be readily accessible to the user and should be isolated from the rest of the spraying device. This is to ensure that the charge generated by the relative motion of the first charge means 32 and the second charge means 38 does not relax after generation.

FIG. 3 illustrates a perspective view of the trigger 14 of an embodiment of the present invention. The trigger 14 is composed of a main housing 48 that is present in the prior art. This housing 48 is shaped to allow a user to grip and actuate the trigger 14. The housing 48 is usually made of a plastics material, such as polyethylene, but may be made of another non conducting material.

Additionally, the trigger 14 further comprises a trigger housing 46 and the conducting element 40. The conducting element 40 traverses the length of the trigger 14 and connects the first charge means 32 to the electrode 42. The conducting element 40 may be in the form of a wire or may be in the form of a conducting sheet insert that is shaped to the trigger 14.

The trigger housing 46 is attached to the trigger 14 and is arranged so that it at least covers the conducting element 40, but preferably is flush with the main housing 48. This give the appearance to the user of a trigger 14 formed of one piece of material. The trigger housing 46 may be made of the same material as the main housing 48 or may be made of a different non-conducting material, for example polypropylene. As the conductive element 40 is isolated from the contents of the spray device 10, the charge on the conductive element 40 does not relax. This means that the charge conducted to the electrode 42 does not relax, so imparting the charge onto the liquid droplets as they are expelled from the nozzle 12.

FIGS. 4a, 4b and 4c illustrate different arrangements of the electrodes 42 for transferring the charge conducted along the conducting element to the liquid droplets as they are formed by the nozzle 12.

Each one of the arrangements shown in FIGS. 4a, 4b and 4c uses a contact type arrangement to transfer the charge generated by the relative movement of the first charge means 32 and the second charge means 38. This contact type of arrangement allows a substantial proportion of the droplets expelled from the nozzle 12 to contact the electrode arrangements as shown in FIGS. 4a, 4b and 4c. This contact allows charge to transfer from the highly charged electrode arrangements to the less charged droplets. After contact, the droplets are more highly charged than before contact, preferably to at least 1×10⁻⁴ C/kg.

FIG. 4a shows the electrode arrangement as being a contact disc 43. The contact disc 43 is made from a conducting material that is shaped as a disc and preferably covers the entire front face of the outside of the nozzle 12. The disc 43 however has a central hole to allow the liquid droplets to pass therethrough. The hole is arranged such that a substantial proportion of the liquid droplets, after expulsion by the nozzle 12, are in contact with the contact disk 43. This allows the contact disk 43 to impart a charge to the droplets, as explained previously.

FIG. 4b shows the contact arrangement as being a toroid 50. The toroid 50 is made from a conducting material and is arranged to be positioned around the outside of the nozzle 12 and to allow the liquid droplets to pass therethrough. The toroid 5o is arranged such that a substantial proportion of the liquid droplets, after expulsion by the nozzle 12, are in contact with the toroid 50, which allows the toroid 50 to impart a charge on the droplets.

FIG. 4c shows the electrode arrangement as a point electrode 52. The point electrode 52 is made from a conducting material and is arranged to be positioned at the outside of the nozzle 12 and not to be in contact with the nozzle 12. The point electrode 52 is arranged such that a substantial proportion of the liquid droplets, after expulsion by the nozzle 12, are in contact with the point electrode 52. This allows the point electrode 52 to impart a charge on the liquid droplets.

It will be understood that there will be other arrangements which allow the charge to be imparted, by contact, to the liquid droplets after being expelled from the nozzle 12. The arrangements shown in FIGS. 4a, 4b, and 4c are only a selection thereof.

FIG. 5 shows a perspective view of a further arrangement to allow charge to be imparted onto the liquid. This arrangement preferably allows a charge/mass ratio of at least ±1×10⁻⁴ C/kg to be imparted onto the liquid as atomisation of the liquid into droplets occurs. This arrangement is hereinafter referred to as an inductive transfer arrangement as it allows a charge to be induced as the droplets are formed, without the need for contact between the droplets and a conductive arrangement as was the case with the arrangements of FIGS. 4a, 4b and 4c. It should be noted that, for a charge to be imparted onto the liquid droplets using the inductive transfer arrangement, the liquid reservoir (not shown) needs to be substantially at ground potential.

This particular inductive transfer arrangement allows charge to be produced by the relative movement of the first charge means 32 with respect to the second charge means 38, this charge then being stored on a charging surface 54. The charging surface 54 surrounds a large proportion of the spraying device 10. It should be noted that the charging surface 54 also extends to the point 56 in the spraying device 10 where the liquid is atomised into droplets. This means that due to the charge stored on the charging surface 54, a high electric field is generated at 56 at the point of atomisation 56. This intense high electric field induces an increased charge on to the droplets 57 as they are produced. As shown the droplets 57 are negatively charged, whilst the charging surface 54 is positively charged. A trigger shield 58 is provided on the spray device on the surface remote from the trigger to enable the user to grip the device without touching the charging surface 54.

It should also be noted that with the inductive transfer arrangement the charging surface 54 may be made of the same material as the first charge means 32. In this case, it is possible to make the charging surface 54 also perform the same function as the first charge means 32.

In other words, the charging surface 54 can be intimately coupled to the second charge means 38 and so actuation of the trigger 14 causes the second charge means 38 to move relative to the charging surface 54 and to generate a charge which is retained on the charging surface 54. In this case, the second charge means 38 will be relocated in the spraying device 10 so that intimate coupling between the charging surface 54 and the second charge means 38 can take place. The charge is then generated and retained locally on the charge surface 54 and the conductive element 40 becomes redundant.

FIGS. 6 and 7 illustrate in more detail parts of the trigger mechanism described with reference to FIG. 1, with like numerals depicting like parts. Upon actuation of the trigger 14 the actuation extension 11 moves with respect to the chassis 16. This is shown more clearly in FIG. 6.

Similarly, with reference to FIG. 7, actuation of the trigger 14, the stem 22 and actuator 20 moves with respect to the chassis 16.

Referring to FIG. 8, an alternative charging mechanism actuated by the trigger of the trigger spray device is shown. The mechanism comprises a polymer wheel 60 mounted on a spindle 61 which has an integrally formed inner toothed wheel 62 mounted on the spindle. The toothed wheel is mounted on a rack 64 which is attached at end 65 to the trigger mechanism (not shown). The upper surface of the polymer wheel contacts a spring loaded conducting electrode 66 which is connected at 67 to a charge storage electrode.

On depression of the trigger (not shown) the movement of the rack 64 causes the inner wheel 62 to rotate which also causes the outer wheel 60 to rotate. Friction between the outer surface of the outer wheel 60 and the stationary surface of the spring loaded conducting electrode 66 generates opposite charges, as shown, on the polymer wheel 66 and the conducting electrode 66. Further charge is generated as the trigger is released and the rack 64 returns to its original position, thereby causing the wheel 62 to rotate in the opposite direction.

The present invention will be further described with reference to the following Examples.

### EXAMPLE 1

The charge-to-mass ratio (q/m) of commercially available trigger actuated products is commonly between 1×10⁻⁸ to 1×10⁻⁶ C/kg. By transferring tribo electrically separate charge onto a spray aerosol it has been possible to increase the q/m to in excess of 1×10⁻⁴ C/kg.

The charge-to-mass ratio of trigger sprays was measured using a Faraday cup connected to an electrometer (Keithley Instruments 610 C solid state). The trigger spray was positioned with the terminal orifice approximately 30 mm from the opening of the Faraday cup, and the trigger squeezed fully by hand such that the aerosol droplets were captured in the cup. The charge on these droplets was registered on the electrometer and the mass of formation captured in the cup measured. The q/m of a minimum of five sprays was recorded and the mean value was calculated. Table 1 lists the mean q/m of some commercially available trigger actuated products.

TABLE 1

| Name of Product | Manufacturer | q/m, C/kg |
|---|---|---|
| Mr Sheen Polish | Reckitt & Colman | +1.64 × 10⁻⁶ |
| Sugar Soap | Mangers | +1.34 × 10⁻⁶ |
| Vanish Stain | Benckiser Ltd | +5.22 × 10⁻⁷ |
| Remover | | |
| Shout Stain | S.C. Johnson Wax | −3.86 × 10⁻⁸ |
| Removing Spray | | |
| Domestos Germ Guard | Lever Bros. Ltd | +8.05 × 10⁻⁶ |
| Mr. Muscle Kitchen | S.C. Johnson Wax | +6.62 × 10⁻⁵ |
| Cleaner | | |

The q/m of trigger actuated sprays has been substantially increased using a charging system in which charge is separated during rubbing of two selected materials, and transfer of this charge to the liquid droplets as they are atomised. In the first instance charge was imparted to the liquid formulation from a copper coil electrode of 1 to 4 mm diameter, located in front of the terminal orifice of the trigger spray device as illustrated in FIG. 4b. The charge in this example results from an aluminium spherical electrode, about 40 mm in diameter, being triboelectrically rubbed against polyethylene. A net charge of approximately 3×10⁻⁸ C can readily be separated by this method. The aluminium electrode is connected to the copper coil electrode at the terminal orifice of the trigger via a thin copper wire. With the coil transfer electrode electrically isolated from the contents of the trigger pack, the charge accumulated during charge separation does not relax. As the liquid contacts the transfer electrode during atomisation, the charge is transferred from the electrode onto the droplets, resulting in the aerosol becoming highly charged. Table 2 shows the q/m of various liquids when sprayed using this method, compared with a trigger pack in which the aluminium sphere is not charged. This is the contact method of charging.

TABLE 2

| Liquid Sprayed | Uncharged Pack | Charged Pack |
|---|---|---|
| Distilled water | +3.65 × 10⁻⁶ C/kg | +8.58 × 10⁻⁵ C/kg |
| Tap water | +8.44 × 10⁻⁶ C/kg | +6.22 × 10⁻⁵ C/kg |
| Mr. Sheen Polish | +1.64 × 10⁻⁶ C/kg | +6.99 × 10⁻⁵ C/kg |
| Vanish Stain | +5.22 × 10⁻⁷ C/kg | +5.73 × 10⁻⁵ C/kg |
| Remover | | |
| Mr Muscle Kitchen | +6.02 × 10⁻⁷ C/kg | +6.62 × 10⁻⁵ C/kg |
| Cleaner | | |
| Sugar Soap | −2.42 × 10⁻⁶ C/kg | +3.48 × 10⁻⁵ C/kg |
| Formulation | | |

### EXAMPLE 2

As an example of induction charging, the outer shield of a standard commercial trigger was coated in aluminium foil, so that the foil extended to the front of the area in which the liquid is atomised. This provides an area of intense electric field at the point of liquid atomisation. This is shown in FIG. 5. The aluminium coated shield is rubbed against a sheet of polyethylene to achieve a mean surface charge of 6×10⁻⁸ C. To demonstrate the effect, the coated shield is charged by simply rubbing it with a polyethylene sheet. When the trigger is depressed the liquid is atomised in a high field zone. The liquid reservoir in the trigger pack is connected to ground so charge is induced in the liquid during spraying. The charge-to-mass ratio of water and a number of commercial formulations are shown in Table 3.

TABLE 3

| | | Induction charged |
|---|---|---|
| Liquid Sprayed | Uncharged Pack | Pack |
| Distilled water | +1.2 × 10⁻⁶ C/kg | −9.91 × 10⁻⁵ C/kg |
| Tap water | +2.08 × 10⁻⁶ C/kg | −1.15 × 10⁻⁴ C/kg |
| Tesco antibacterial | +8.13 × 10⁻⁷ C/kg | −1.22 × 10⁻⁴ C/kg |
| cleaner | | |
| Mr Muscle Kitchen | −5.22 × 10⁻⁷ C/kg | −8.38 × 10⁻⁵ C/kg |
| cleaner | | |

1. A spray device for dispensing charged liquid droplets comprising;
a trigger coupled to a means for dispensing a predetermined volume of a liquid and to a first charge means;
said means for dispensing the liquid being arranged to dispense the predetermined volume of liquid by actuation of the trigger;
outlet means coupled to the means for dispensing the predetermined volume of liquid;
the first charge means being intimately coupled to a second charge means, whereby actuation of the trigger permits movement of the first charge means relative to the second charge means, and thereby imparts a first charge on the first charge means and a second charge on the second charge means;
the first charge means being further arranged to be within close proximity of the outlet means; and
the first and second charge means comprising different tribocharging materials.

2. A spray device according to claim 1 further comprising charge conducting means connectively coupled to the first charge means.

3. A spray device according to claim 2, further comprising an electrode connectively coupled to said charge conducting means whereby the charge generated by the relative movement of the first and second charge means is transferred thereto.

4. A spray device according to claim 3, wherein the electrode is arranged so that, in use, a substantial proportion of liquid droplets are in forcible collision with the electrode after atomisation.

5. A spray device according to claim 4, wherein the electrode comprises a disc of conducting material coupled to the outlet means.

6. A spray device according to claim 4, wherein the electrode comprises a point electrode isolated from the outlet means.

7. A spray device according to claim 4, wherein the electrode comprises a toroid positioned in front of the outlet means.

8. A spray device according to claim 1 which comprises a charge storage means arranged so that an electric field created by the charge present on the charge storage means is exerted in use, on a substantial portion of the liquid during atomisation.

9. A spray device according to claim 1, further including a liquid reservoir connectively coupled to pump means wherein the liquid reservoir is arranged to store the liquid for dispensing.

10. A spray device according to claim 1, wherein the first charge means comprises a conducting material.

11. A spray device according to claim 10, wherein the conducting material is aluminium.

12. A spray device according to claim 10, wherein the conducting material is celluloid.

13. A spray device according to claim 10, wherein the conducting material is a conducting polymer or static dissipative polymer.

14. A spray device according to claim 13, wherein the conductive Dolymer or static dissipative polymer is filled with carbon black or metallic elements.

15. A spray device according to claim 1, wherein the second charge means consists of a polyfluorinated hydrocarbon polymer.

16. A spray device according to claim 1, wherein the second charge means consists of polyethylene.

17. A method of dispensing charged liquid droplets from a trigger actuated spray device comprising the steps of:
coupling a trigger to a means for dispensing a predetermined volume of a liquid from a reservoir of the liquid and to a first charge means;
dispensing the predetermined volume of liquid by the actuation of said trigger;
connecting an outlet means to the means for dispensing the predetermined volume of the liquid;
intimately coupling the first charge means to a second charge means, the first charge means and the second charge means comprising different tribocharging materials and moving relative to each other upon actuation of the trigger;
imparting a first charge on the first charge means and a second charge on the second charge means by actuation of the trigger; and
arranging for charge separation to occur and transferring one polarity of the separated charge to the liquid being dispensed.

18. A method according to claim 17 wherein the charge imparted to the liquid droplets is at a level such that the said droplets have a charge to mass ratio of at least ±1×10⁻⁴ C/kg.

19. A method according to claim 17 wherein the liquid droplets sprayed from the spray device have a range of average droplets sizes in the range of from 5 to 100 micrometers.

20. (canceled)

21. (canceled)

22. (canceled)

23. A method according to claim 18 wherein the liquid droplets sprayed from the spray device have a range of average droplets sizes in the range of from 5 to 100 micrometers.
